(19) United States
(12) Patent Application Publication
(10) Pub. No.: US 2014/0074478 A1
(43) Pub. Date: Mar. 13, 2014

(54) SYSTEM AND METHOD FOR DIGITALLY REPLICATING SPEECH

(71) Applicants: Heath Ahrens, Boonton, NJ (US); Florencio Isaac Martin, Paterson, NJ (US); Tyler A.R. Auten, Montville, NJ (US)

(72) Inventors: Heath Ahrens, Boonton, NJ (US); Florencio Isaac Martin, Paterson, NJ (US); Tyler A.R. Auten, Montville, NJ (US)

(73) Assignee: ISPEECH CORP., Newark, NJ (US)

(21) Appl. No.: 13/606,946

(22) Filed: Sep. 7, 2012

(51) Int. Cl. G10L 13/08

(52) U.S. Cl. 704/260; 704/E13.011

(57) ABSTRACT

A speech replication system including a speech generation unit having a program running in a memory of the speech generation unit, the program executing the steps of receiving an audio stream, identifying words within the audio stream, analyzing each word to determine the audio characteristics of the speaker's voice, storing the audio characteristics of the speaker's voice in the memory, receiving text information, converting the text information into an output audio stream using the audio characteristics of the speaker stored in the memory, and playing the output audio stream.

### BACK GROUND OF THE INVENTION

Many text to speech conversion systems are used in the current market. These systems parse a file for text and convert the text into an audio stream. However, many of these systems utilize a computer rendered voice that does not sound like a natural human voice. In addition, the voices used by text to speech software do not convey emotions that are typically conveyed by a user's voice. Accordingly, these voices tend to sound very cold and inhuman.

Further, while many text to speech software programs allow a user to select from a variety of different voices, current software systems do not allow for a user to generate an audio stream using the user's voice. Accordingly, present technology does not provide for a system where a user can construct audio streams that generate a voice that is identical, or similar, to the user's voice.

Accordingly, a need exists for a software system that allows a user to record their voice and to generate an audio stream from text where the audio stream incorporates the user's voice or characteristics of the user's voice.

### SUMMARY OF THE INVENTION

Various embodiments of the present provide a speech replication system including a speech generation unit having a program running in a memory of the speech generation unit, the program executing the steps of receiving an audio stream, identifying words within the audio stream, analyzing each word to determine the audio characteristics of the speaker's voice, storing the audio characteristics of the speaker's voice in the memory, receiving text information, converting the text information into an output audio stream using the audio characteristics of the speaker stored in the memory, and playing the output audio stream.

Another embodiment provides a speech replication system including a speech generation unit having a program running in a memory of the speech generation unit, the program executing the steps of receiving text information, identifying each word in the text information, searching the memory for audio information of a previously selected speaker for each identified word, searching the memory for audio information of a speaker having characteristics similar to the previously selected speaker when audio information of a word is not located for the previously selected speaker, generating an output audio stream based on the audio information, and playing the output audio stream.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 depicts a block diagram of a voice categorization system suitable for use with the methods and systems consistent with the present invention;

FIG. 2A shows a more detailed depiction of an iSpeech device included in the voice characterization system of FIG. 1;

FIG. 2B shows a more detailed depiction of a user' computer;

FIG. 3A is a schematic representation of one embodiment of the operation of the voice categorization system;

FIG. 3B depicts word information stored in the word storage unit of FIG. 2A;

FIG. 4 depicts a schematic representation of the iSpeech device of FIG. 1 generating an audio file based on received text; and

FIG. 5 depicts an illustrative example of a user registering with the voice categorization system.

### DETAILED DESCRIPTION OF THE DRAWINGS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

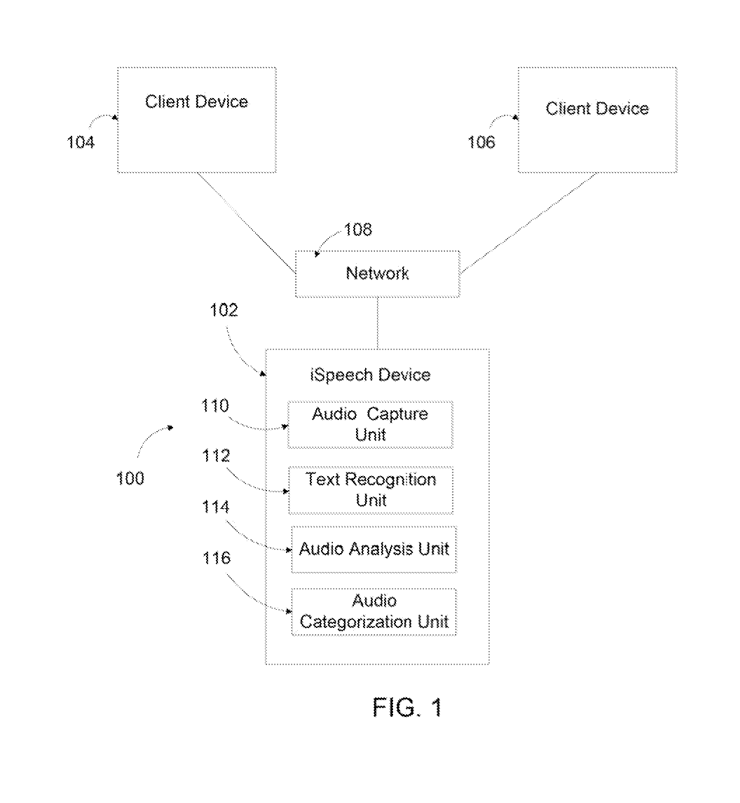

FIG. 1 depicts a block diagram of a voice categorization system 100 suitable for use with the methods and systems consistent with the present invention. The voice categorization system 100 comprises a plurality of computers 102 and 104 and a plurality of mobile communication devices 106 connected via a network 108. The network 108 is of a type that is suitable for connecting the plurality of computers 102 and 104 and the plurality of mobile communication devices 106 for communication, such as a circuit-switched network or a packet-switched network. Also, the network 108 may include a number of different networks, such as a local area network, a wide area network such as the Internet, telephone networks including telephone networks with dedicated communication links, connection-less network, and wireless networks. In the illustrative example shown in FIG. 1, the network 108 is the Internet. Each of the plurality of computers 102 and 104 and the plurality of mobile communication devices 106 shown in FIG. 1 is connected to the network 108 via a suitable communication link, such as a dedicated communication line or a wireless communication link.

In an illustrative example, computer 102 serves as an iSpeech device that includes an audio capture unit 110, a text recognition unit 112, an audio analysis unit 114, and an audio categorization unit 116. The number of computers and the network configuration shown in FIG. 1 are merely an illustrative example. One having skill in the art will appreciate that the data processing system may include a different number of computers and networks. For example, computer 102 may include the audio capture unit 110, as well as, one or more of text recognition unit 112, or the audio analysis unit 114. Further, the audio categorization unit 116 may reside on a different computer than computer 102.

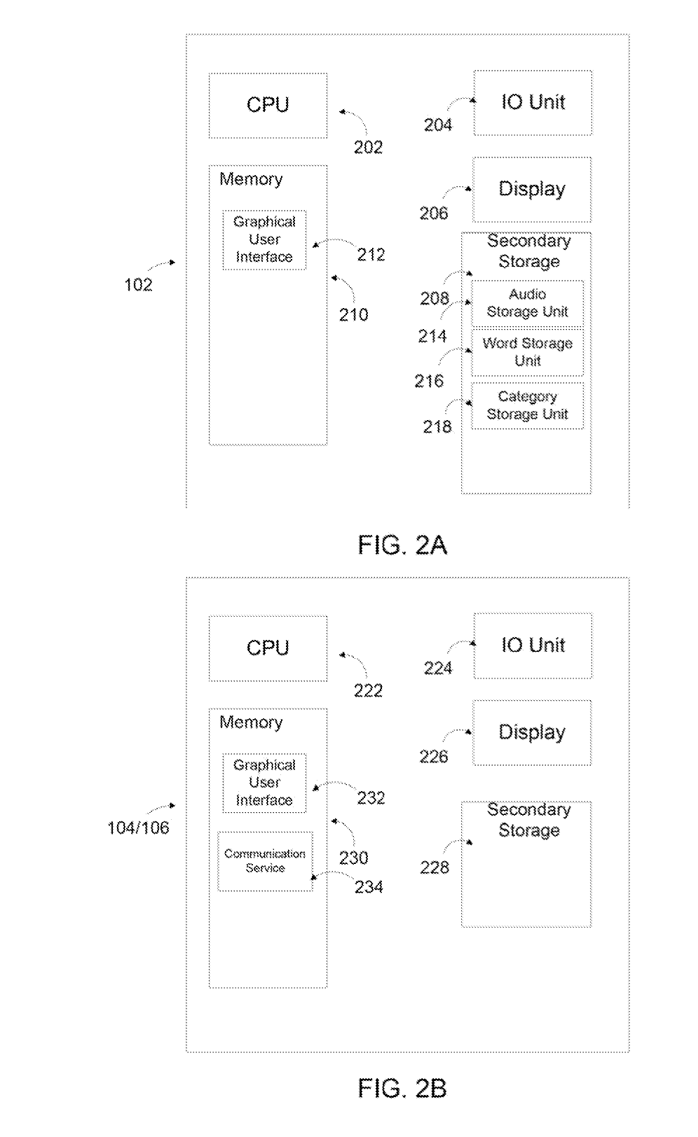

FIG. 2A shows a more detailed depiction of an iSpeech device 102. The iSpeech device 102 comprises a central processing unit (CPU) 202, an input output (UO) unit 204, a display device 206, a secondary storage device 208, and a memory 210. The iSpeech device 102 may further comprise standard input devices such as a keyboard, a mouse, a digitizer, or a speech processing means (each not illustrated).

The iSpeech device 102's memory 210 includes a Graphical User Interface (GUI) 212 which is used to gather information from a user via the display device 206 and I/O unit 204 as described herein. The GUI 212 includes any user interface capable of being displayed on a display device 206 including, but not limited to, a web page, a display panel in an executable program, or any other interface capable of being displayed on a computer screen. The secondary storage device 208 includes an audio storage unit 214, a word storage unit 216, and a category storage unit 218. Further, the GUI 212 may also be stored in the secondary storage unit 208. In one embodiment consistent with the present invention, the GUI 212 is displayed using commercially available hypertext markup language (HTML) viewing software such as, but not limited to, Microsoft Internet Explorer®, Google Chrome® or any other commercially available HTML viewing software.

FIG. 2B shows a more detailed depiction of a user computer 104 and a mobile communication device 106. Computer 104 and mobile device 106 each comprise a CPU 222, an I/O unit 224, a display device 226, a secondary storage device 228, and a memory 230. Computer 104 and mobile device 106 may further each comprise standard input devices such as a keyboard, a mouse, a digitizer, or a speech processing means (each not illustrated).

The memory 230 in computer 104 and mobile device 106 includes a GUI 232 which is used to gather information from a user via the display device 226 and I/O unit 224 as described herein. The GUI 232 includes any user interface capable of being displayed on a display device 226 including, but not limited to, a web page, a display panel in an executable program, or any other interface capable of being displayed on a computer screen. The GUI 232 may also be stored in the secondary storage unit 228. In one embodiment consistent with the present invention, the GUI 232 is displayed using commercially available HTML viewing software such as, but not limited to, Microsoft Internet Explorer, Google Chrome® or any other commercially available HTML viewing software.

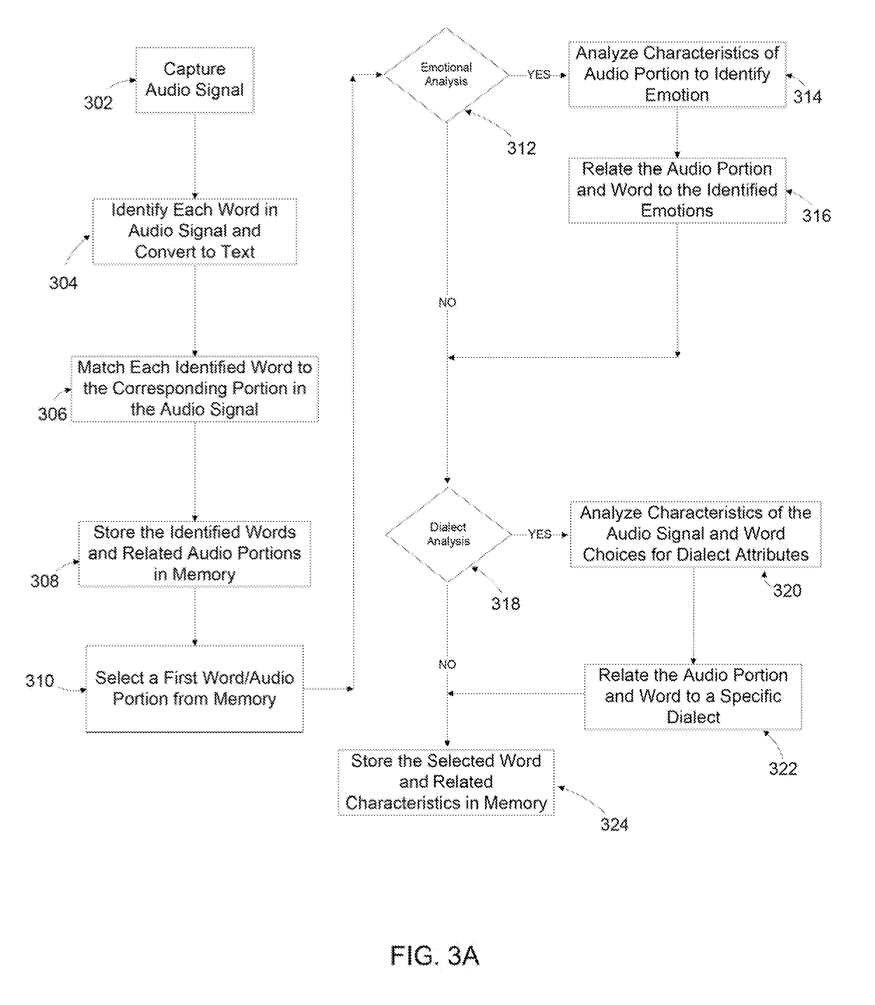

FIG. 3A is a schematic representation of one embodiment of the operation of the voice categorization system 100. In step 302, the audio capture unit 110 in the iSpeech device 102 captures an audio stream from a device via the network 108. Audio may be captured by a microphone coupled to the iSpeech device 102, computer 104, or mobile communication device 106, and converted into a digital signal that is stored in the memory 210 or 230 as an audio file. The audio stream may also be stored in the secondary storage 208 or 228. The audio may be stored in any known digital format including, but not limited to, MPEG Layer III, Linear PCM, Real Audio format, GSM, or any other audio format. The audio capture unit 110 may also remove audio interference, such as noise, from the audio file to enhance the audio characteristics of a speaker's voice. The audio capture unit 110 may utilize known noise reduction software such as, but not limited to, DART Audio Reduction, Audacity, or any other noise reduction software.

In step 304, the text recognition unit 112 identifies each word in the audio stream. A word is interpreted herein to include the phonetic representation of a cognizable sound, portion of a word, a word, or the like, the audio characteristics of an utterance the word, a digital representation of the sound generated by the utterance of the word, or a statistical representation of the utterance of the word. In addition, the word may include a portion of a word or character, phoneme, or multiple words and characters combined together to form a phrase or sentence. The text recognition unit 112 may utilize any known speech to text software, or any software capable of converting an audio stream to a text based document, including, iSpeech Speech to Text, Microsoft Speech to Text, Dragon Naturally Speaking, or any other known speech to text software.

In step 306, the audio analysis unit 114 correlates each identified word with the corresponding portion of the audio stream where the word is uttered, and converts the word into text. In step 308, the converted text and the portion of the audio stream where the word occurs is stored in the word storage unit 216 in the memory 210, or secondary storage 208, of the iSpeech device 102 or in the memory 230, or second storage unit 228, or the computer 104 or 106. In step 310, the audio analysis unit 114 selects a first word from the audio stream for analysis.

In step 312, the audio analysis unit 114 determines if an emotional analysis should be performed on the audio stream, or an identified word in the audio stream. The audio analysis unit 114 may determine if an emotional analysis should be performed based on information included in the audio stream, such as an indicator embedded in the audio stream that indicates an emotional analysis should be performed. In addition, the characteristics of the audio stream may also indicate that the audio stream should be subjected to an emotional analysis. The characteristics of the portions of the audio stream where the word is uttered may also determine if an emotional analysis should be performed. As an illustrative example, the utterance of particular words may trigger an emotional analysis of the entire audio stream, or a portion of the audio stream. Further, the audio characteristics, or changes in the audio characteristics, of the utterance of a word such as the speed, pitch, tone, or intensity of the word utterance or audio stream, may trigger an emotional analysis if the values are near a predetermined threshold.

If an emotional analysis is triggered, the audio analysis unit 114 analyzes each audio portion for characteristics identifying the emotion of the speaker generating each word step 314. The word storage unit 216 may include a listing of words, or statistical models of different words, with corresponding emotions associated with each word. The word storage unit 216 may also include a listing of words associated with a particular emotion. The word storage unit 216 may be structured such that each word stored in the word storage unit 216 is related to multiple other words and emotions as will be discussed herein. By relating words, emotions, or external information, the audio analysis unit 114 can determine potential emotions conveyed by the speaker based on the combination of words used. External information may include audio characteristics of the same or similar phrases uttered by at least one other speaker.

The word storage unit 216 may also include various audio attributes, identified by the audio analysis unit 114, that indicate what emotion is conveyed by the speaker. The audio attributes may include, but are not limited to, syllables per time unit, range of frequency, intensity, volume, amplitude, inflection, average length of vowel sounds, average length of consonant sounds, time between words, time between sentences, vowel to consonant ratio, sound to silence ratio, cadence, prosody, intonation, rhyme, rhythm, meter, consistency, pitch, tone, variation, timbre, language, dialect, age, gender, socioeconomic categorization. The emotions identified based on the audio analysis include, but are not limited to, angst, anxiety, affection, emotion, fear, guilt, love, melancholia, pain, paranoia, pessimism, patience, courage, hope, lust, anger, pride, epiphany (feeling), limerence, repentance, shame, insult, pleasure, happiness, jealousy, nostalgia, revenge, hysteria, fanaticism, humiliation, suffering, shyness, world view, remorse, emotional insecurity, embarrassment, sadness, grief, boredom, forgiveness, kindness, optimism, empathy, doubt, panic, compassion, apathy, horror and terror, or any other emotion identifiable by audio stream analysis.

The audio analysis unit 114 may also gather information from the speaker, via the GUI 212, indicating the emotion conveyed in the speaker's voice. In step 316, the audio analysis unit 114 relates each audio portion and corresponding words to at least one emotion indicator in the word storage unit 216 based on the analysis performed by the audio analysis unit 114. The audio analysis unit 114 may also generate a value signifying the quality of the audio stream. The quality of the audio stream may be affected by noise, incoherent speech, interference, or any other sound that may affect the quality of the audio stream.

In step 318, the audio analysis unit 114 determines whether to analyze the audio stream for dialect information. The audio analysis unit 114 may determine if a dialect analysis should be performed based on information included in the audio stream, such as an indicator embedded in the audio stream that indicates a dialect analysis should be performed. In addition, the characteristics of the audio stream may also indicate that the audio stream should be subjected to a dialect analysis. The words identified in the audio stream may also determine if a dialect analysis should be performed. As an illustrative example, the use of particular words, or the ordering of particular words, may trigger a dialect analysis of the utterance of the identified word or of the entire audio stream.

In step 320, the audio analysis unit 114 analyzes the characteristics and word arrangements of each audio stream to determine a language dialect. The audio analysis unit 114 may examine the audio file and associated identified text for spelling and word arrangements that would indicate a particular dialect. Further, the audio analysis unit 114 may analyze the audio stream portions corresponding to each word for distinctive dialect patterns, such as phonetic emphasis, the length of each audio portion, the exact spelling of each word based on the pronunciation of each word by the speaker, or any other attribute that would identify a dialect of a speaker. In step 322, the audio analysis unit 114 relates the audio portion and the word related to the audio portion to a dialect in the word storage unit 216.

The iSpeech device 102 may store a listing of known words in the word storage unit 216. Each word stored in the word storage unit 216 may be related to an emotion, a phonic indicator, and a word category stored in the category storage unit 218. Further, the word storage unit 216 may include information indicating the likelihood of a word proceeding or following another word. In step 324, the iSpeech device 102 stores each selected word in the word storage unit 216, and selects another word for analysis.

The iSpeech device 102 may analyze the identified words using statistical modeling, such as statistical parametric speech analysis. Using this approach, a statistical model of each word is generated based on speech characteristics of the speaker. The iSpeech device 102 stores the statistical model of each spoken word in the word storage unit 216. The statistical model of the spoken word may include a baseline value for the intensity, speed, duration, tone, pitch, or any other audio characteristic of the utterance. The statistical model may be generated using any known statistical modeling process including, but not limited to, HMM synthesis, or HSMM synthesis. The iSpeech device 102 may generate a baseline statistical value for each characteristic and store the baseline values in the word storage unit 216.

FIG. 3B depicts an illustrative example of word information stored in the word storage unit 216. Each word and associated audio file may be stored in a data format that logically relates different words together using different criteria. A word may be related to other words based on related emotions, usage rules, or a common theme. Further, the words may be related to an audio file containing an utterance, or a statistical representation of the utterance, of the word.

Returning to FIG. 3B, the words RUN 350 and AWAY 352 are stored as nodes in the word storage unit 216. A node being defined as a unit, or collection of units, or information. The audio file portion 354 corresponding to RUN 350 is extracted from the audio stream, and is stored as a node and is related to RUN 350. The audio portion 356 corresponding to the word AWAY 352 is extracted from the audio stream, and is stored as a node in the word storage unit 216. The audio file may be a reference to the location of the audio file in the audio storage unit 214. RUN 350 and AWAY 352 are related by edge 358, which includes information on the relationship between RUN 352 and AWAY 354. An edge is defined as a relationship between two nodes. As an illustrative example, the information may include the frequency with which AWAY 352 precedes RUN 350 and frequency with which AWAY 352 follows RUN 350 in normal usage.

The audio files 354 and 356 may be related to emotion nodes, such as FEAR 360, HAPPINESS 362, or any other emotional indicator. Each audio file may be related to one or more emotional nodes based on the characteristics of the audio file, and the audio stream from which the audio file is extracted. Further, the characteristics used to associate the emotional node with the audio file may be stored in the edge relating the emotional node to the audio file.

The word storage unit 216 may also store statistical models of different words. The statistical model may include the frequency spectrum, fundamental frequency, and duration of a typical utterance of a word by a speaker having no accent.

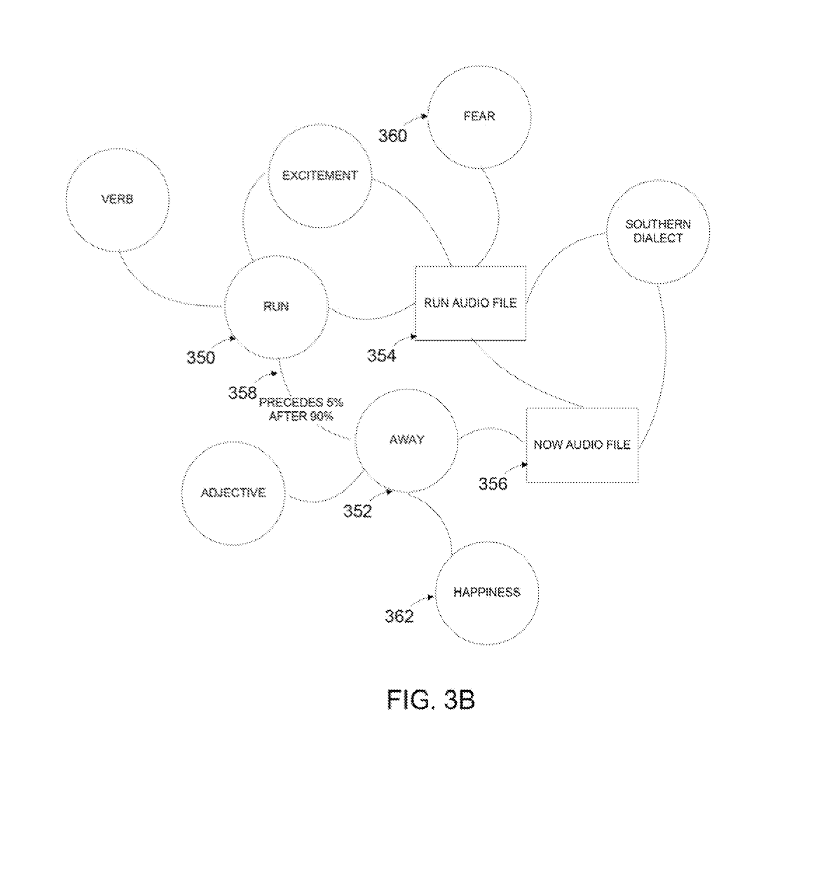

FIG. 4 depicts a schematic representation of the iSpeech device 102 generating an audio file based on received text. In step 402, the iSpeech device 102 receives information for conversion into an audio stream. The information may be sent from a user having audio samples stored in the audio storage unit 214, or via a device 106 or computer 104 connected to the network 108. In step 404, the audio analysis unit 114 analyzes the received information, and extracts the text to be converted into an audio signal along with the defining characteristics of the audio signal. As an illustrative example, the information may include symbols indicating a specific emotion to invoke for different words in the text. The information may also include the characteristics of the voice and dialect to be used in generating the audio stream.

In step 406, the audio analysis unit 114 separates the text in the information into individual words. The audio analysis unit 114 may separate the text into words using any conventional word identification technique, including identifying spaces between portions of text, matching letter patterns, or any other word identification technique. In step 408, the audio analysis unit 114 searches the word storage unit 216 for an audio file, or a statistical model, reciting each word that matches the voice characteristics included in the information, or that is assigned to the specific voice included in the information. As an illustrative example, the audio analysis unit 114 may search the word storage unit 216 for an audio file associated with the speaker where the word RUN 354 is uttered, and the utterance is associated with excitement. The audio analysis unit 114 may also search based on additional characteristics, such as pitch, speed, and intensity of the audio in each audio file. The audio analysis unit 114 may also search the statistical models stored in the word storage unit 216 for a statistical model of the utterance of the word as will be discussed herein.

In step 410, the audio analysis unit 114 determines if the word, or statistical model of the word, has been found in the word storage unit 216. If the word is not identified in the word storage unit 216, the audio analysis unit 114 searches for similar words, or similarly sounding words based on the statistical model of the speaker, in step 412. If the word has been found, the process proceeds to step 414. In determining if a word is similarly sounding, the audio analysis unit 114 may search the word storage unit 216 for words having a statistical model that closely matches the statistical model of the speaker.

In step 412, if a word cannot be located in the word storage unit 216 that matches the voice characteristics of the speaker, the audio analysis unit 114 adjusts the voice characteristics used in the search and performs a second search for a similar voice reciting the word with the required characteristics. In addition, if the statistical model for the word cannot be located, the audio analysis unit 114 may identify words having similar statistical models, and adjust the statistical models of the identified words to match the speaker's statistical model. In addition, the audio analysis unit 114 may search the word storage unit 216 for audio files having voice characteristics similar to the speaker. The voice characteristics may include, but are not limited to pitch, quality, timbre, harmonic content, attack and decay, or intensity. Further, the audio analysis unit 114 may only search audio files associated with a dialect identified by the user, or by the audio analysis unit 114. The audio analysis unit 114 may also generate an audio file of the word based on the statistical model of the speaker stored in the word database.

In step 414, the audio analysis unit 114 analyzes the words preceding and following the selected word, and analyzes the results received form the word storage unit 216 based on the words preceding and following the selected word. The audio analysis unit 114 may search the word storage unit 216 for similarly categorized words, or words phonetically similar, to the words preceding or following the selected word. In step 416, the audio analysis unit 114 selects an audio file, or statistical model that most closely fits the characteristics associated with the selected word, and stores this audio file in the memory or secondary storage of the iSpeech device or the computer.

In step 418, after all identified words have an associated audio file or statistical model, the audio analysis unit 114 combines all of the selected audio files in to a single audio file or stream. The audio analysis unit 114 may apply a smoothing algorithm to the audio file or stream to blend the transitions between the audio file segments.

The audio analysis unit 114 may also adjust characteristics of an audio file to mimic a specific emotion. The word storage unit 216 may include a listing of emotional states and the corresponding pitch levels associated with each emotional state for each speaker stored in the system. The audio analysis unit 114 may query the word storage unit 216 to extract the pitch settings for a desired emotion, and apply these pitch settings to one or more audio files to mimic the desired emotion. The pitch settings may be stored as a numeric value representing a frequency of the pitch. The audio analysis unit 114 may adjust a sampling rate of an audio file by the adjustment level to mimic a specific emotion.

The audio analysis unit 114 may also store audio samples of known emotional states of a user in the audio storage unit 216. The audio analysis unit 114 may analyze the audio files of known emotional states and store the pitch and speed characteristics in the edges connecting the audio files to the emotional states in the database of FIG. 3B.

The audio analysis unit 114 may also generate an audio file using the statistical model for the speaker. To generate the audio file using the statistical model, the audio analysis unit 114 generates a wave for using the statistical model of each word identified as being spoken by the speaker. If the statistical model of a word has not been identified for the speaker, the audio analysis unit 114 adjusts the characteristics of the identified similar statistical models such that the generated file sounds similar to the speaker. The identified similar statistical models may be a non dialect base statistical model for a specific utterance. The audio analysis unit 114 adjusts the different characteristics of the base statistical model to generate a new audio file that is adjusted to the settings of the speaker. After the statistical model is adjusted, the audio analysis unit 114 generates an audio signal based on the new statistical model. The new audio signal can be generated using any known audio signal generation software.

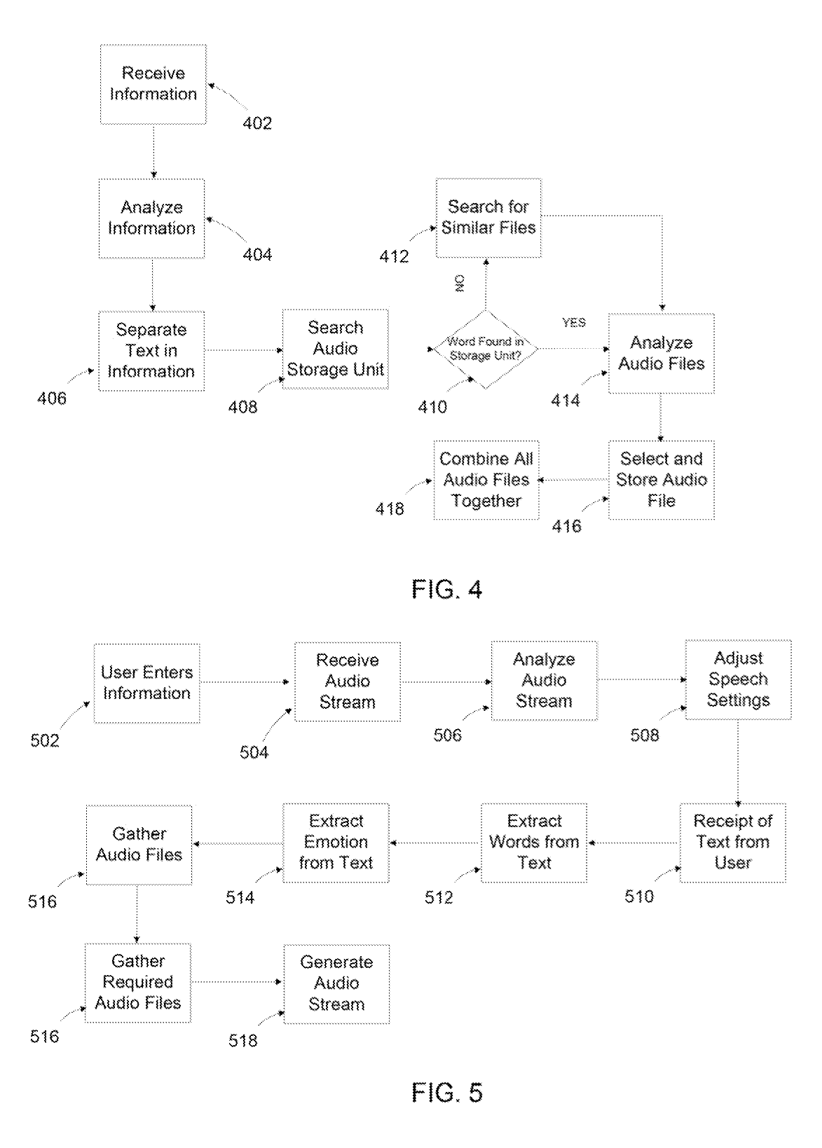

FIG. 5 depicts an illustrative example of a user registering with the voice categorization system 100, and generating a voice profile. In step 502, identifying information is gathered from the speaker. The user may also manually enter identifying information. Identifying information includes but is not limited to, information such as age, location, sex, profession, or any other information that can identify the speaker. In step 504, the audio capture unit 110 receives an audio stream from the user. The audio stream may be a stored audio file or a live audio stream sent from the user to the audio capture unit 110. In step 506, the audio stream is analyzed using the previously disclosed techniques. In step 508, the user adjusts the transcription of the audio stream, or assigns a quality indicator to the audio stream before sending. The user may provide audio files of the user speaking in different emotional states, and relate these audio samples to the specific emotions in the word storage unit 216. The audio analysis unit 114 extracts the words and audio characteristics from these files and stores the results in the audio storage unit 214 using the method discussed in FIG. 3B.

In step 510, the user transmits text to the audio receiving unit 112. The text may include a destination address, such as a cellular phone number, and a message to convey to the cellular phone number as an audio stream. In step 512, the audio analysis unit 114 extracts all words from the text. The words may be extracted using any known word extraction method such as, but not limited to identifying blank spaces between groups of characters. In step 514, the audio analysis unit 114 extracts emotional indicators from the text. The emotional indicators may be text or symbols provided in a specific format from the user. The user may include emoticons in the text that indicate the emotion associated with the preceding words. The audio analysis unit 114 may also determine an emotional state of the text by analyzing the arrangement of words in the text.

In step 516, the audio analysis unit 114 gathers the audio files matching the words extracted from the text using the method disclosed in FIG. 3B. The audio analysis unit 114 may also adjust each audio file to match the required emotion using the previously discussed techniques. In step 518, the audio analysis unit 114 generates an audio stream be combining each audio file as previously discussed. In step 520, the audio analysis unit 114 transmits the generated audio stream to the receiving device via the network 108. A user of the receiving device may open the audio stream to play an audio representation of the text message.

The audio analysis unit 114 may determine the location of the receiving device before generating the audio file to determine if a particular language translation is required. The audio analysis unit 114 may also determine the location of the user to determine if a specific dialect or language model should be implemented. The audio stream may include the text sent from the user. The receiving device may present an option for a user of the audio device to read the text or hear the audio message.

The audio analysis unit 114 may analyze the arrangement of words in each text message to determine the structure of each sentence. The audio analysis unit 114 may add, delete, or rearrange words to generate a more natural sounding audio stream. The word storage unit 216 may include information pertaining to the normal arrangement of certain words in the edges connecting the words in the word storage unit 216.

The audio analysis unit 114 may also transmit the statistical model of the message to the receiving device. Upon receipt, an application operating in the memory of the receiving device may generate an audio signal based the received statistical model.

The iSpeech device 102 may also present a client device 104 with an interface that allows a user to specify the location of text on the network 108 to convert to an audio stream. The user may select a known voice, from a list of voices presented to the user, to read the text at the specified location. The iSpeech device may automatically develop a listing of celebrity voices by locating audio streams of a celebrity speaking and converting the celebrity's voice into a statistical model that can be used to regenerate the celebrity's voice. The text recognition unit 112 retrieves the text from the specified location and stores the text in the memory of the iSpeech device 102, and identifies the words in the text using any of the previously described methods. The words may be identified in real time, such that each word, or series of words, is identified and converted into audio as the words are gathered.

The words are converted into an audio stream using the statistical model of the voice selected. As an illustrative example, the user may select the voice of a celebrity to read a web site. The text recognition unit 112 retrieves the text from the web site, and the audio analysis unit 114 converts the text into an audio stream using the statistical model of the celebrity voice. The audio stream is then played to the user.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A speech replication system including a speech generation unit having a program running in a memory of the speech generation unit, the program executing the steps of:
intercepting an audio stream;
identifying words within the audio stream;
analyzing each word to determine the audio characteristics of the speaker's voice;
storing the audio characteristics of the speaker's voice in the memory;
receiving text information;
converting the text information into an output audio stream using the audio characteristics of the speaker stored in the memory; and
playing the output audio stream.

2. The speech replication system of claim 1 wherein the audio characteristics are stored as a statistical model.

3. The speech replication system of claim 1 wherein the text information includes indicators of the emotional context of each word.

4. The speech replication system of claim 3 including the step of modifying the output audio stream based on the emotional indicators.

5. The speech replication system of claim 1 including the step of identifying a dialect in the received audio stream.

6. The speech replication system of claim 5 including the step of generating a statistical model of the speaker's dialect and storing the dialect statistical model in the memory.

7. The speech replication system of claim 1 wherein the text information is text displayed on a web page.

8. The speech replication system of claim 1 including the step of relating each identified word to an emotion based on the audio characteristics of the audio stream.

9. The speech replication system of claim 1 including the step of determining the probability of a first word preceding or following a second word.

10. The speech replication system of claim 1 including the step of valuating the quality of the audio stream and storing the valuation in the memory.

11. A speech replication system including a speech generation unit having a program running in a memory of the speech generation unit, the program executing the steps of:
receiving text information;
identifying each word in the text information;
searching the memory for audio information of a previously selected speaker for each identified word;
searching the memory for audio information of a speaker having characteristics similar to the previously selected speaker when audio information of a word is not located for the previously selected speaker;
generating an output audio stream based on the audio information; and
playing the output audio stream.

12. The speech replication system of claim 11 wherein the audio characteristics are stored as a statistical model.

13. The speech replication system of claim 11 wherein the text information includes indicators of the emotional context of each word.

14. The speech replication system of claim 13 including the step of modifying the output audio stream based on the emotional indicators.

15. The speech replication system of claim 11 wherein the audio information includes dialect information.

16. The speech replication system of claim 15 wherein the audio information includes emotion information.

17. The speech replication system of claim 11 wherein the text information is text displayed on a web page.

18. The speech replication system of claim 11 including the step of relating each identified word to an emotion based on the audio characteristics of the audio stream.

19. The speech replication system of claim 11 including the step of determining the probability of a first word preceding or following a second word.

20. The speech replication system of claim 11 including the step of valuating the quality of the audio stream and storing the valuation in the memory.
